(19) United States
(12) Patent Application Publication
(10) Pub. No.: US 2017/0135490 A1
(43) Pub. Date: May 18, 2017

(54) OFFICE CLIMATE CONTROL SYSTEM AND METHOD

(71) Applicant: GENTHERM INCORPORATED, Northville, MI (US)

(72) Inventors: Dennis Craig Andrix, Harrison Township, MI (US); Vladimir Jovovic, Pasadena, CA (US); Wayne Swoyer Kauffman, III, Oak Park, MI (US); Dmitri Kossakovski, South Pasadena, CA (US); David Marquette, Farmington Hills, MI (US); Daniel J. Pace, Plymouth, MI (US); Darren Andrew Schumacher, Ann Arbor, MI (US); John Terech, Milan, MI (US); Robert M. Vidojevski, Brownstown, MI (US)

(21) Appl. No.: 15/317,757

(22) PCT Filed: Jun. 11, 2015
(86) PCT No.: PCT/US15/35269

§ 371 Date: Dec. 9, 2016

Related U.S. Application Data
(60) Provisional application No. 62/010,982, filed on Jun. 11, 2014.

(51) Int. Cl. A47C 7/74; H02J 50/10; A47C 31/00; A47C 21/04; A61G 5/10; H02J 7/02; H02J 7/00

(52) U.S. Cl. CPC A47C 7/748; H02J 7/025; H02J 50/10; H02J 7/0047; A47C 21/048; A61G 5/10; A47C 31/008

(57) ABSTRACT

A support device or chair can include an inductive charging systems can be used to charge a battery. The chair or support device can include a climate control system to provide personal comfort to an occupant, such as an office worker, using personal thermal amenity devices.

### PRIORITY INFORMATION

This application claims priority to U.S. Provisional Patent Application Ser. No. 62/010,982, filed Jun. 11, 2014, the entirety of which is hereby expressly incorporated by reference herein.

### BACKGROUND

Field

This disclosure relates generally to inductive charging systems used to charge a battery installed into a movable surface.

Description of the Related Art

Temperature modified air for environmental control of living or working space is typically provided to relatively extensive areas, such as entire buildings, selected offices, or suites of rooms within a building. In the case of enclosed areas, such as homes, offices, libraries and the like, the interior space is typically cooled or heated as a unit. There are many situations, however, in which more selective or restrictive air temperature modification is desirable. For example, it is often desirable to provide an individualized climate control for a seat assembly so that substantially instantaneous heating or cooling can be achieved. For example, a chair situated within a hot, poorly-ventilated environment can be uncomfortable to the occupant, especially if the occupant intends to use the chair for extended time periods. Furthermore, even with normal air-conditioning, on a hot day, the seat occupant's back and other pressure points may remain sweaty while seated. In the winter time, it is highly desirable to have the ability to quickly warm the seat of the occupant to facilitate the occupant's comfort, especially where heating units are unlikely to warm the indoor space as quickly. Therefore, a need exists to provide a climate-controlled seat assembly, bed, or other movable surface for use in various indoor and/or outdoor environments.

### SUMMARY

In certain embodiments, it may be desirable to provide movable surfaces (such as hospital beds, wheelchairs, or other supportive surfaces) or devices with a rechargeable battery or other rechargeable power source, thereby allowing for the device to be powered and readily transported without being limited by the length of electrical power cords or the like. In some embodiments, the charging can be accomplished with a physical electrical connection, such as a plug or other electrical connection that is connected with the device during charging and then disconnected when charging is complete. In other embodiments, charging can be accomplished by removing a battery and charging the battery with a charging device. However, such configurations can be inconvenient due to the requirement of connecting and disconnecting the physical electrical connections.

As described herein, in some embodiments, moveable surfaces or devices can avoid the need for such a physical electrical connection by being configured to accept wireless charging such as inductive or resonance mode charging. Wireless charging such as inductive charging can use electromagnetic fields to transfer power from a transmitter (e.g., a dock) to a receiver (e.g., the power source in the surface or device) that is in close proximity to the transmitter. As power is transferred via the electromagnetic fields, a physical electrical connection between the transmitter and the receiver is not required, thus eliminating the inconvenience associated with connecting and disconnecting the physical electrical connection.

Certain embodiments described herein comprise movable surfaces (e.g., hospital beds, wheelchairs, office chairs, and otherwise) with an inductive charging station. Such a design can allow users to place the movable surface in a dock (e.g., a pad, recess, slot, or otherwise) that has inductive charging functionality, thereby providing inductive charging without the inconvenience of a connecting and disconnecting a physical electrical connection.

Certain embodiments described herein provide wireless charging systems (such as an inductive charging system) that may be used to charge a battery installed in a support surface such as a moveable bed or chair and/or to directly power various components carried by the support surface. These systems provide convenient ways to charge the battery or power various components without the use of cords. At least some embodiments disclosed herein provide at least one of the following advantages compared to conventional charging methods: increased durability, increased safety, and increased convenience. The charging system can be used to power any of a variety of types of components carried by the support surface such as, for example, a climate control system, USB charging station, speakers, lumbar support devices, displays, power motors, massage devices, etc.

Certain embodiments described herein provide climate control systems and methods for an office that control the office climate and provide personal comfort to an occupant, such as an office worker, using personal thermal amenity devices. These systems provide climate control and personal comfort within the office independent of areas outside the office. At least some embodiments disclosed herein provide at least one of the following advantages compared to conventional building HVAC systems: improved personal thermal comfort of individual office occupants, reduced demand on central building HVAC systems, lower building operating costs, and increased optimization of energy usage (e.g. electricity) for building climate control.

In one aspect, a charging system for a moveable surface includes a rechargeable battery connected to the moveable surface, a receiver connected to the moveable surface and to the battery, a transmitter connected to a power supply, and an alignment mechanism that is configured to align the transmitter with the receiver when at least a portion of the moveable surface is in proximity to the transmitter such that when the transmitter and the receiver are aligned the battery is being at least partially recharged. In some embodiments, the moveable surface is one of a bed, wheelchair, or office chair. In some embodiments, the transmitter is on one of a desk, wall, or floor mat. In some embodiments, the receiver and transmitter are aligned in each of the X, Y, and Z directions. In some embodiments, the transmitter is connected to a rotatable member pivotally connected to a surface. In some embodiments, the transmitter is connected to a hinged support that extends from a housing connected to a surface. In some embodiments, the receiver is connected to an armrest of a moveable chair such that at least a portion of the chair approaches the transmitter, the rotatable member allows the transmitter to align with the receiver. In some embodiments, the transmitter is positioned within a channel or recess configured to receive a structure of the chair comprising the receiver. In some embodiments, the system further includes a visual indicator that activates when the transmitter and the receiver are aligned and the battery is at least partially being recharged. In some embodiments, the alignment mechanism comprises a pair of magnets.

In another aspect, a climate controlled seating assembly includes a front side and a rear side, said front side of the seating assembly being generally adjacent to a seated occupant, at least one covering material located along the front side of the climate controlled seating assembly, said at least one covering material being generally air-permeable and being configured to contact a seated occupant, a fluid module connected to a distribution system configured to distribute air through the at least one covering material toward one or more targeted areas of a seated occupant, a rechargeable battery connected to the fluid module and configured to power the fluid module, a receiver connected to the seating assembly and to the battery, and a transmitter connected to a power source. In some embodiments, the assembly includes an alignment mechanism that configured to align with the transmitter with the receiver when at least a portion of the seating assembly is in proximity to the power source such that when the transmitter and the receiver are aligned the battery is at least partially recharged. In some embodiments, the moveable surface is one of a bed, wheelchair, or office chair. In some embodiments, the transmitter is on one of a desk, wall, or floor mat. In some embodiments, the receiver and transmitter are aligned in each of the X, Y, and Z directions. In some embodiments, the transmitter is connected to a rotatable member pivotally connected to the stationary surface. In some embodiments, the transmitter is connected to a hinged support that extends from a housing connected to a surface. In some embodiments, the transmitter is positioned within a channel or recess configured to receive a structure of the chair comprising the receiver. In some embodiments, the assembly further includes a visual indicator that activates when the transmitter and the receiver are aligned and the battery is at least partially being recharged.

In certain embodiments, the charging system can include an alignment mechanism. In some embodiments, the alignment mechanism is configured to bring the coils of the transmitter and receiver within a certain range with respect to the X, Y, and/or Z distance to facilitate more efficient wireless inductive charging. In some embodiments, with respect to the Z distance, the alignment mechanism is configured such that a distance between the coils of the transmitter and the coils of the receiver is 1 to 10 mm in the Z direction and in another embodiment 1 to 5 mm in the Z direction. In some embodiments, with respect to the X and Y directions, the alignment mechanism is configured to place the centers of the coils of the receiver and coils of the transmitter 0 to 10 mm of each other in an X-Y plane and in another embodiment 5 and 25 mm of each other in the X-Y plane. In another embodiment with respect to the X and Y directions, the alignment mechanism is configured such that in an X -Y plane there is 30% or less area offset between the coils of the receiver and coils of the transmitter (with area offset being defined as the percentage area of within the coils not overlapped in the X-Y plane by the other coil).

In yet another aspect, a wireless charging system for a moveable surface includes a receiver connected to the moveable surface and to a battery, a transmitter connected to a power supply, and an alignment mechanism that is configured to align the transmitter with the receiver when at least a portion of the moveable surface is in proximity to the transmitter such that when the transmitter and the receiver are aligned the power is being transmitted from the transmitter to the receiver.

In yet another aspect, a moveable support surface includes a receiver for a wireless charging system. The moveable support surface in one arrangement is an office chair. The moveable support surface can include an electrical component. In one arrangement, the moveable surface includes a battery connected to the electrical component that is charged by the receiver. In one arrangement, the receiver can power the electrical component. The moveable support surface can be used in combination with a transmitter connected to a power supply. In one arrangement, the receiver and/or the transmitter are coupled to an alignment mechanism that is configured to align the transmitter with the receiver. In one arrangement, in combination with or as an alternative to an alignment mechanism, the receiver and/or the transmitter is coupled to a visual indicator that is configured to indicate when the transmitter and the receiver are aligned and power is being transmitted from the transmitter to the receiver. The electrical component can be any of a variety of types of components carried by the moveable surface such as, for example, a climate control system, USB charging station, speakers, lumbar support devices, displays, power motors, and/or massage devices.

In another aspect, a method of wireless charging a rechargeable battery or powering electrical components carried by a moveable surface includes the steps of moving a device comprising an electrical component and a receiver towards a transmitter, the rechargeable battery connected to the moveable surface and aligning the transmitter with the receiver using an alignment mechanism to wirelessly provide power to the battery or the electrical component.

### BRIEF DESCRIPTION OF THE DRAWINGS

Various embodiments are depicted in the accompanying drawings for illustrative purposes, and should in no way be interpreted as limiting the scope of the inductive charging systems and methods and office climate control systems and methods disclosed herein. In addition, various features of different disclosed embodiments can be combined with one another to form additional embodiments, which are part of this disclosure. Any feature or structure can be removed, altered, or omitted. Throughout the drawings, reference numbers may be reused to indicate correspondence between reference elements.

FIG. 1 is a perspective view of a seating assembly that includes a climate control system configured in accordance with one embodiment;

FIG. 2 is a side perspective view of the seating assembly of FIG. 1;

FIG. 3 is a rear view of the seating assembly of FIG. 1;

FIG. 4A is a seating assembly such as the one illustrated in FIG. 3 with a rear panel removed from the backrest portion according to one embodiment;

FIG. 4B is the rear panel of FIG. 3 comprising a fluid distribution system along its interior surface according to one embodiment;

FIG. 5 schematically illustrates a system for powering an inductive charger;

FIG. 6 is a perspective view of a seating assembly that includes an inductive charging system configured in accordance with one embodiment;

FIGS. 7A-D are perspective and side views illustrating an exemplary view of an inductive charging system with desk transmission according to the present disclosure;

FIGS. 8A-B are perspective views illustrating another exemplary inductive charging system with desk transmission according to the present disclosure;

FIGS. 9A-C are perspective views illustrating another exemplary inductive charging system with desk transmission according to the present disclosure;

FIGS. 10A-D are perspective and side views illustrating another exemplary inductive charging system with desk transmission according to the present disclosure;

FIGS. 11A-B are perspective views illustrating another exemplary inductive charging system with floor mat transmission according to the present disclosure;

FIGS. 12A-B are perspective and side views illustrating another exemplary inductive charging system with an alignment mechanism according to the present disclosure;

FIG. 13 is a side view illustrating another exemplary inductive charging system with an alignment mechanism according to the present disclosure;

FIG. 14 is functional block diagram illustrating an exemplary building climate control system according to the present disclosure;

FIG. 15 is a functional block diagram illustrating an exemplary office climate control system according to the present disclosure;

FIG. 16 is a perspective view illustrating an exemplary office climate control system according to the present disclosure.

### DETAILED DESCRIPTION

The present teachings are illustrated by embodiments and examples disclosed herein, however the present teachings apply beyond the examples and embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

The discussion below and the figures referenced therein describe various embodiments of a support surface that can include a wireless charging system such as an inductive or resonance mode charging system. In certain embodiments, the support surface includes a mechanism that can be used to align and/or shorten the distance between the transmitter and the receiver of the charging system. Such an arrangement is particularly useful for inductive charging systems where a shorter distance between the receiving and transmitter coils tends to increase performance and efficiency. The charging system can be used to power any of a variety of types of components carried by the seating assembly such as, for example, a climate control system, USB charging station, speakers, lumbar support devices, displays, power motors, massage devices, etc.

In certain embodiments, the wireless charging system can be used to provide power to a climate control system and in such embodiments the climate control system can include an air moving device (AMD), a thermoelectric device (TED), a heater mat, a control module, and sub-combinations and/or combinations thereof.

Those of skill in the art will appreciate that the term control module as used herein can refer to, be a part of, or comprise a processor that executes code; an Application Specific Integrated Circuit (ASIC); an electronic circuit; a combinational logic circuit; a field programmable gate array (FPGA); a hard-wired feedback control circuit; other suitable components that provide the described functionality; or a combination of some or all of the foregoing. The control module can further comprise memory (shared, dedicated, or group) that stores code executed by the control module.

The discussion below and the figures referenced therein describe various embodiments of a wireless charging system and/or a climate control system in the context of a support surface that is a seating assembly. A number of these embodiments are particularly well suited to serve as ergonomic office chairs. However, it will be appreciated that the climate control and/or wireless charging features described herein may be incorporated into other types of seat assemblies, including recliner chairs, medical chairs, chemotherapy chairs, dentist chairs, wheelchairs, other chairs where occupants are seated and/or supported for extended time periods, sofas, beds, automobile seats, airplane seats, stadium seats, benches, wheelchairs, outdoor furniture and the like. Regardless of their exact configuration, the seat assemblies can be sized, shaped, manufactured and otherwise designed and configured to accommodate occupants of various size, shape and weight. In some embodiments, the climate control devices and/or charging features described herein can be incorporated into other types of support structures and/or components thereof (e.g., beds, armrests, neck or foot supports, etc.). In addition, the wireless charging system described below will often be described in the context of an inductive charging system. However, that in modified embodiments the wireless charging system can utilize a resonance mode charging system or other mode of wireless charging

### Climate Controlled Seating Assembly

As mention, in one embodiment, a wireless charging system can be used to provide power to one or more components of a climate controlled seating assembly. A climate controlled seating assembly can help increase the overall comfort level for the occupant, especially if the occupant tends to be situated within the seating assembly for extended time periods (e.g., medical chairs such as chemotherapy or dentist chairs, hospital beds, office chairs, etc.). By regulating the flowrate and/or the temperature of fluid delivered to or near the interface between the seating assembly and the occupant, the climate control features described below can help reduce perspiration, avoid skin irritation and discomfort, improve the general comfort level of the occupant and the like. In addition, such seat assemblies can provide other benefits, such as, for example, energy savings, as the importance of regulating the temperature of an entire room or some other enclosed space is diminished. Thus, the seating assembly can provide localized temperature control even when the surrounding ambient temperature is outside of a desirable range.

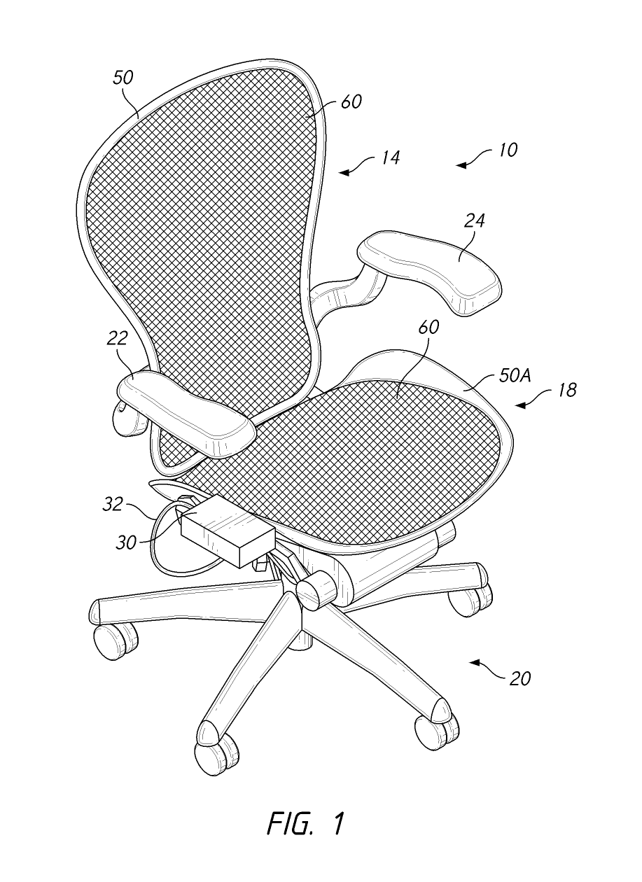

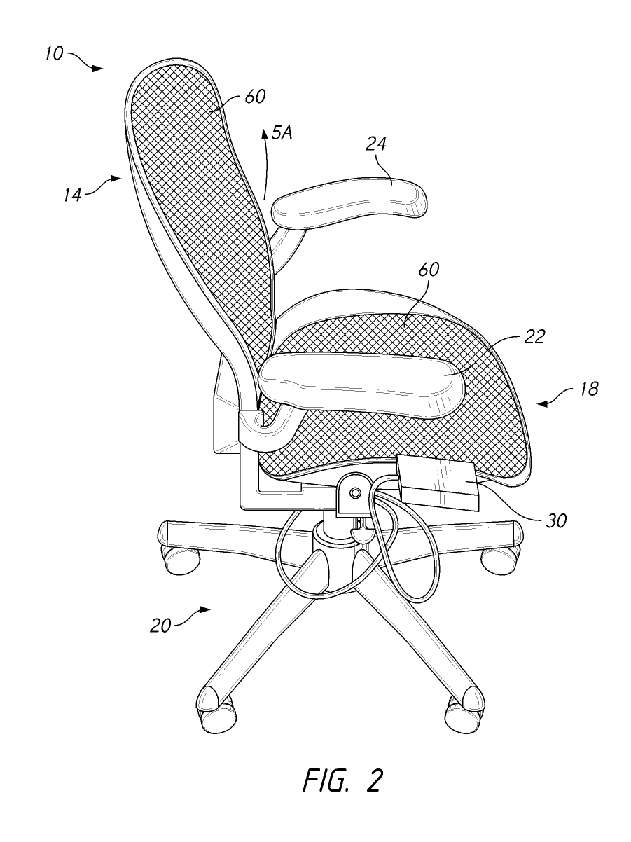

In the illustrated embodiments of FIGS. 1 and 2, a seating assembly 10 can comprise a backrest portion 14 and a bottom seat portion 18. The seating assembly 10 can also include a bottom base 20, which in the depicted embodiment, enables an occupant to easily move the chair assembly 10 relative to a floor or another bottom surface through the use of one or more bottom wheel assemblies. In addition, the seating assembly can be configured to swivel or rotate about a central axis. The seating assembly 10 can also include one or more other features, such as, for example, armrests 22, 24, to further enhance the appearance and/or functionality of the seating assembly 10. In some embodiments, the seating assembly 10 includes one or more adjustment controls (e.g., knobs, levers) that permit the position, tension and other characteristics of the various seating assembly components (e.g., backrest portion, bottom seat portion, armrests, etc.) to be adjusted, as desired or required by a particular user or application.

In some embodiments, the seating assembly 10 includes one or more climate control systems, the operational settings of which can be controlled using a control unit 30. The control unit 30 can be situated so that it is easily accessible to an occupant while he or she is positioned within or near the seating assembly 10. For example, in FIGS. 1 and 2, the control unit 30 is positioned underneath an armrest 22, next to the bottom seat portion 18. However, in other embodiments, the control unit 30 can be positioned in one or more other locations than illustrated herein. The control unit 30 can be equipped with an extension cord 32, making it easier for an occupant to handle or manipulate the control unit 30 during use. In other embodiments, the control unit 30 is positioned at any other location or may be configured to remotely communicate with the climate control system of the chair assembly such as application of a smart device (smart phone, laptop, or personal computer). The climate control system and the control unit are described in more detail below. Additional details related to the seating assembly 10 may be found in U.S. Pat. No. 7,963,594 titled “CHAIR WITH AIR CONDITIONING DEVICE,” which is herein incorporated by reference in its entirety in this application.

With continued reference to FIGS. 1 and 2, when positioned on the seating assembly 10, an occupant may contact both a backrest portion 14 and a bottom seat portion 18. Thus, in some embodiments, the backrest portion 14 and the bottom seat portion 18 cooperate to support the occupant generally in a sitting position. However, in other embodiments where the backrest portion 14 can be tilted relative to the bottom seat portion 18, the seating assembly 10 may be configured to support an occupant in a different position (e.g., reclined, horizontal, substantially horizontal, etc.). Moreover, the various embodiments of the climate control system and/or inductive charging systems described herein and/or modifications thereof can also be incorporated into seat assemblies of different configurations including recliner chairs, medical chairs, chemotherapy chairs, dentist chairs, wheelchairs, other chairs where occupants are seated and/or supported for extended time periods, sofas, beds, automobile seats, airplane seats, stadium seats, benches, wheelchairs, outdoor furniture and the like. In some embodiments, the climate control devices and/or inductive charging features described herein or modifications thereof can also be incorporated into other types of support structures and/or components thereof (e.g., beds, armrests, neck or foot supports, etc.).

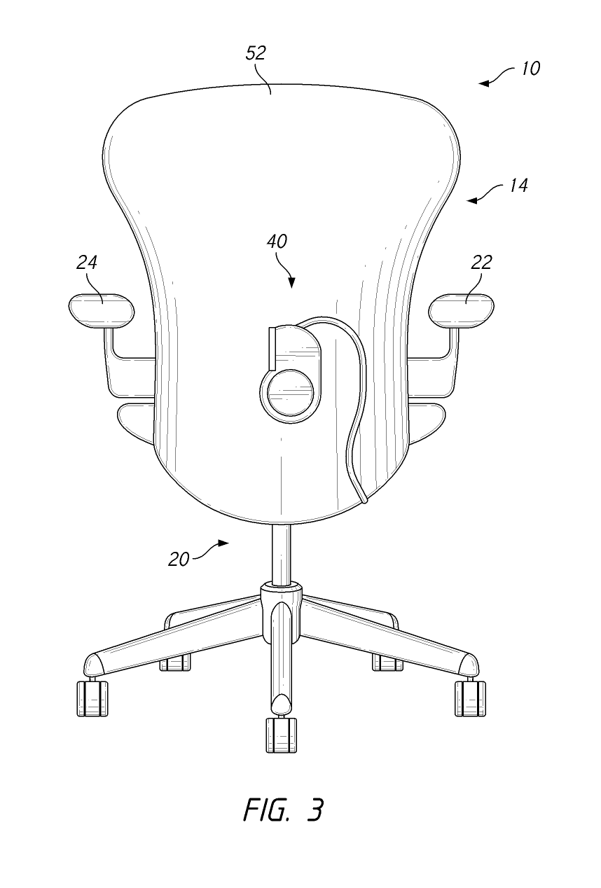

FIG. 3 illustrates a rear view of the seating assembly of FIGS. 1 and 2. In the depicted embodiment, the backrest portion 14 includes a rear panel 52 to which is attached a fluid module 40. Although the illustrated backrest portion 14 includes only a single fluid module 40, it will be appreciated that additional fluid modules can be provided in order to deliver the desired or required fluid volume to the seating assembly. In addition, fluid modules can also be provided to the bottom seat portion 18 and/or any other component or portion of a climate controlled seating assembly 10.

As discussed in greater detail herein, fluid modules can be configured to provide temperature conditioned and/or unconditioned air or other fluid (and/or to remove air or fluid) to one or more distribution systems positioned within or adjacent to one or more seating assembly components. In this manner, fluid modules can help provide a fluid flow to warm and/or cool an outer surface of the seating assembly that interfaces with an occupant. Alternatively, the fluid modules can deliver ambient air to and/or or from areas near a seating assembly, without providing any temperature conditioning at all. The fluid modules can include heating and/or cooling elements such as a thermoelectric device (TED) (e.g., Peltier circuit) or a resistive heating element) that are configured to alter the temperature of a fluid being delivered to the seating assembly. In addition, a fluid module can include an air moving device (AMID) (e.g., an axial or radial fan) in order to transfer the air or other fluid to and/or from the seating assembly and/or move the air or other fluid through or past the heating and/or cooling elements. However, in other embodiments, the fluid modules can be configured to provide unconditioned air (e.g., ambient air) to the front surface of the backrest portion 14, bottom seat portion 18 and/or any other part of the seating assembly 10. In such embodiments, the fluid modules may include only an air moving device (AMD) to facilitate movement of the air or other fluid during to and/or from a seating assembly. Accordingly, as used herein, “fluid module” is a broad term and may be used to describe any device capable of transferring a fluid and/or selectively temperature conditioning a fluid. In addition, in some embodiments, one or more surfaces of the seating assembly can include a heating mat (e.g., a resistive heating element) positioned along surface of the seat. Such heating mats can be provided in embodiments of a seating assembly or support structure that do not include a fluid module. Additional details and embodiments of such devices and climate control assemblies can be found in U.S. Pat. Nos. 7,665,803; 8,181,290; and 8,332,975, which are hereby incorporated by reference in their entirety into this application.

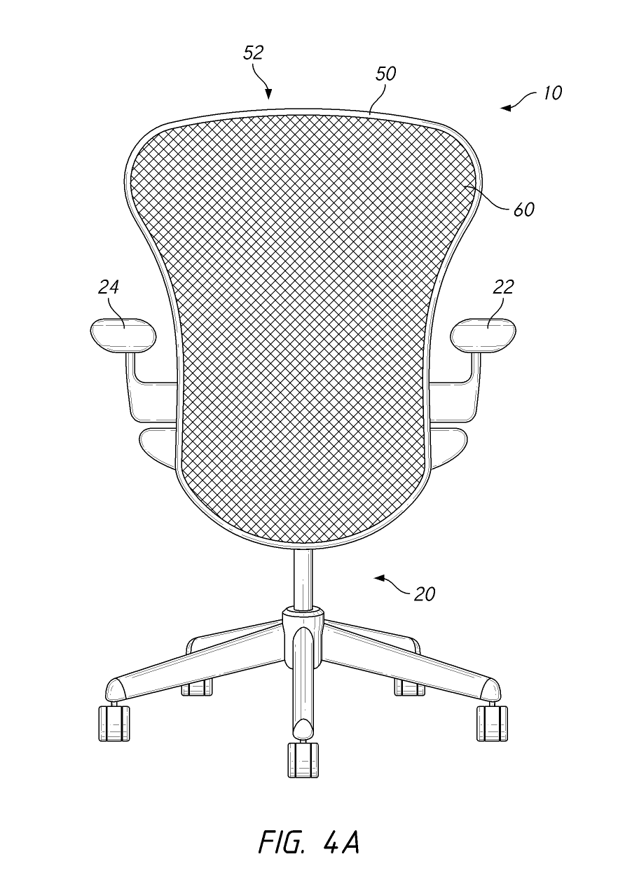

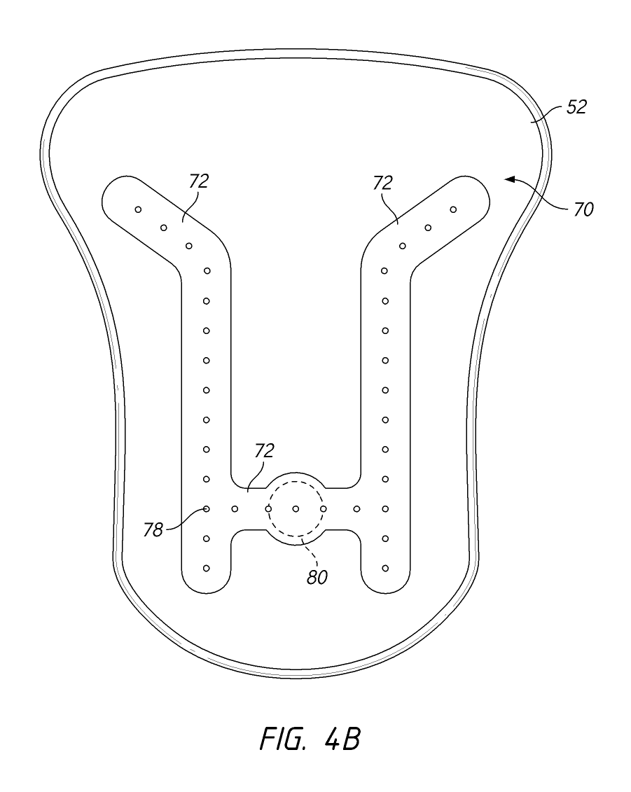

FIG. 4A illustrates a rear view of the seating assembly 10 of FIG. 3 with a rear panel 52 removed from the backrest portion 14 to illustrate a mesh fabric 60 that can generally extend across a frame structure 50. In some embodiments, the frame member 50 comprises one or more strong and durable rigid or semi-rigid materials that are capable of maintaining the shape and structural integrity of the frame member 50. For example, the frame member can comprise metal (e.g., steel, aluminum, etc.), graphite or other composites, plastic and/or the like. The mesh fabric 60 can be constructed of plastic, other polymeric material and/or the like. In addition, the mesh fabric 60 can comprise one or more layers, as desired or required by a particular application or use. In some embodiments, the mesh fabric 60 is a flexible, open weave material that is configured to permit air and other fluids to pass through it. The mesh fabric 60 (the opposite side of which is illustrated in FIGS. 1 and 2), the frame member 50, the connection between the fabric 60 and the frame member 50 and/or one or more other seating assembly features and components can be advantageously configured to adequately and safely support the weight of a seating assembly occupant. Accordingly, the climate controlled seating assembly 10 may not require any cushioned portions or other similar components.

With reference to FIG. 4B, the rear panel 52 of the seat assembly 10 can include a fluid distribution system 70, which, in some embodiments, may comprise one or more distribution channels 72 that are in fluid communication with one another. In the arrangement shown in FIG. 4B, the distribution system 70 includes two main channels that extend generally vertically along a substantial distance of the rear panel 52. These two channels (or more or fewer channels, based on the particular configuration) can be placed in fluid communication with one another using one or more horizontally-oriented channels. Of course, it will be appreciated that the shape, size, orientation, general configuration and/or other details of the distribution system 70 can be different than illustrated in FIG. 4B and described herein.

The climate controlled assemblies shown in FIGS. 1-4B and described above generally require power for operation. As such, many of these assemblies include a rechargeable battery or other rechargeable power source, thereby allowing for the assembly to be powered and readily transported without being limited by the length of electrical power cords or the like. However, electrical power cords can become tangled or may be damaged by the wheels of the assembly as it is moved. These corded connections can be inconvenient due to the requirement of connecting and disconnecting the physical electrical connection. The following assemblies can incorporate wireless (e.g., inductive) charging to avoid the need for a physical electrical connection.

### Wireless Charging Systems

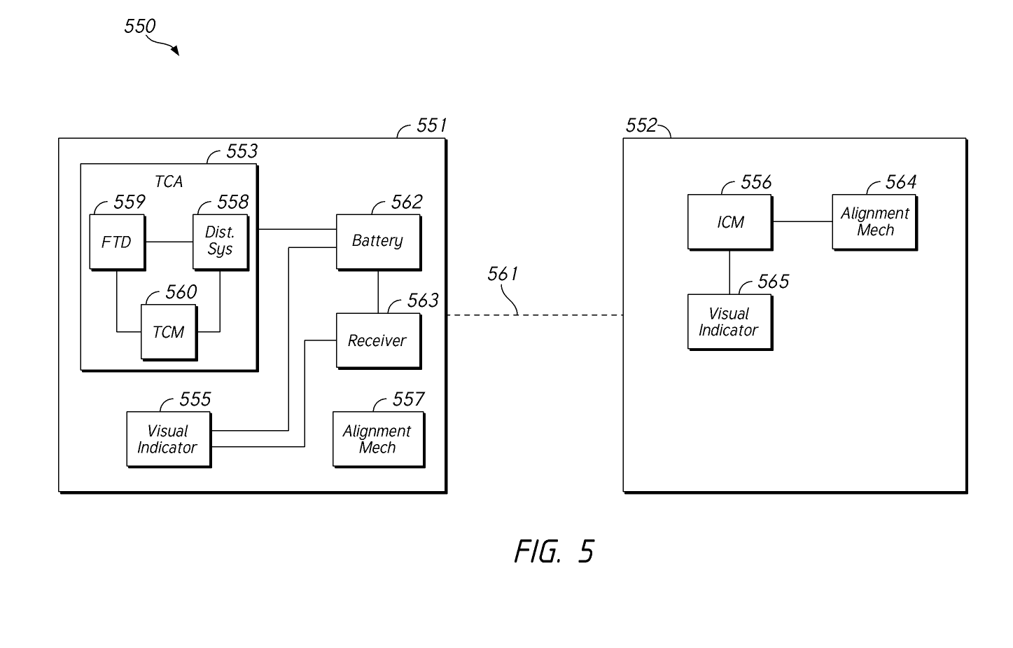

With reference to FIG. 5, a system 550 for wireless (e.g., inductive) charging of a support surface is illustrated. In some embodiments, the system 550 includes a support surface 551, which can be a moveable support surface such as a chair or bed, and a wireless charging assembly 552, which in the illustrated embodiment can be an inductive charging assembly. As noted above, the wireless charging assembly 552 can be used to power a variety of components carried by the support surface. In the illustrated embodiment, the powered component is a thermal conditioning assembly 553 that can be in electrical or electromagnetic communication 561 with the inductive charging assembly 552. In various implementations, the support surface 551 can be part of moveable chair or support structure such as a bed. In some embodiments, the system is incorporated, at least partially, into one or more other components of the surface (e.g., back rest, arm rest, etc.) of the support surface 551.

In certain implementations, the thermal conditioning assembly 553 includes one more of the following: a fluid transfer device 559 (such as, e.g., a pump, blower, or fan), ducting or a distribution system 558 (e.g., a fluid line, coupling, piping, tubing, etc.), thermal conditioning module 560 (e.g., thermoelectric devices (TEDs), conductive heat transfer devices, refrigeration device, a ventilation device that uses no active cooling, other cooling or ventilation devices, etc.), sensors (e.g., temperature sensors, humidity sensors, condensation sensors, etc.), timers and/or the like. As used herein, the term thermal conditioning module has the same meaning as the term thermal conditioning device, which has the same meaning as the term thermal module. In some embodiments, the thermal conditioning assembly 553 comprises a fluid transfer device 559 and no active cooling components or features. The thermal conditioning assembly 553 can be electrically connected to a battery 562 which is electrically connected to a receiver 563 configured for inductive charging. The battery can be used to power components of the thermal conditioning assembly 553 such as the fluid transfer device 559 and/or the thermal conditioning module 560.

Certain implementations of the charging assembly 552 include an alignment mechanism 564 and/or a transmitter 556 (e.g., an inductive charging module or coil). In various embodiments, the alignment mechanism 564 is a space configured to support, hold, and/or receive some or all of a device that contains the receiver 563 (e.g., an inductive charging receiver). For example, the alignment mechanism 564 can be a pad, recess, slot, opening, and/or otherwise. In some embodiments, the alignment mechanism comprises a generally open structure (e.g., without any enclosed or partially enclosed spaced), such as a planar surface. In other embodiments, the alignment mechanism is at least partially enclosed and comprises an interior space. In some implementations, the alignment mechanism 564 includes padding or other shock and/or vibration dampening structures. The transmitter 556 can be integrated into the assembly or can be separate and district from it, as desired or required. In some embodiments, the alignment mechanism 564 can align the transmitter 556 with the receiver 563 on the moveable surface 551 and/or bring the receiver 563 and the transmitter 556 closer together. In some embodiments, as described below, the alignment mechanism can include a pivoting, hinging or rotating arm to bring the receiver 563 and the transmitter 556 closer together and/or within an X, Y, Z distance range as described herein for efficient wireless charging. As discussed in greater detail below, the alignment mechanism 564 can be magnetic, manually-operated, or automatically controlled. The inductive charging assembly 552 can also include a visual indicator 565 to indicate proper alignment of the receiver 563 with the transmitter of the transmitter 556. In the illustrated embodiment, the charging assembly 552 includes an alignment mechanism for physically receiving and/or aligning and/or bringing closer together the transmitter 556 with the receiver 563 of the moveable surface. However, in modified embodiments, the moveable surface 551 and the receiver 563 can be associated with an alignment mechanism physically receiving and/or aligning the transmitter 556 with the receiver 563. In such embodiments, the alignment mechanism can be used in combination with the alignment mechanism of charging assembly 552 and/or as an alternative to one or both components.

The transmitter 556 can be configured to provide wireless charging (e.g., inductive charging) functionality or other assembly equipped with a receiver 563 that is configured to accept wireless (e.g., inductive or resonance) charging and is placed in and/or on the alignment mechanism 564. For example, the transmitter 556 can be configured to generate an electromagnetic field to transfer power to a receiver-equipped assembly mounted in the alignment mechanism 564. Certain variants of the transmitter 556 (e.g., an inductive coil, circuit, or otherwise) are positioned in, on, adjacent, or near the alignment mechanism 564. In some embodiments, the transmitter 556 can receive electrical power from an electrical system, such as a power bus, battery, or otherwise.

In some implementations, the battery 562 can electrically power one or more components of a device carried by the surface 551. In the illustrated embodiment, the battery 562 powers the thermal conditioning assembly 553. The battery 562 can be electrically connected to a visual indicator 555 to indicate an amount of charge of the battery, an estimated time remaining until full charge or until battery depletion, or proper alignment of the receiver 563 with the transmitter of the inductive charging module 556. While the illustrated embodiment includes a battery 562, the circuits within the system 550 can also be configured to directly source power to the powered components. That is in such embodiments there is wireless (e.g., inductive) supply of power to the powered components which can be done in addition to or as an alternative to wireless (e.g., inductive) charging of a batter.

In embodiments that have a thermal conditioning assembly 553, such embodiments can include ducting 558 (e.g., duct, coupling, or other fluid passage) that is in fluid communication with the fluid transfer device 559. The ducting 558 can also be in fluid communication with a thermal conditioning module 560 (e.g., TED), the alignment mechanism 564, one or more sensors, and/or any other components or devices, as desired or required. Certain implementations of the thermal conditioning assembly 552 include the fluid transfer device 559 and thermal conditioning module 560 in a single housing. For example, in some embodiments, the fluid transfer device 559 is connected with the thermal conditioning module 560 without ducting 558. However, in alternative embodiments, one or more components can be included in separate (e.g., adjacent or non-adjacent) housing or casings.

As noted above, the thermal conditioning module 560 can comprise a TED, such as a Peltier device. In some embodiments, the TED includes at least one pair of dissimilar materials (e.g., a series of n-type and p-type semiconductor elements) that are connected electrically in series and thermally in parallel. An electrical circuit can be configured to pass current through the dissimilar materials so as to selectively create a cooled side and an oppositely oriented heated side, depending on the direction of electrical current passing through the TED. In some embodiments, the dissimilar materials are mounted between a pair of plates positioned on the cold and hot sides of the TED. The plates can provide for heat conduction and electrical insulation.

The support surface 551 can also comprise an alignment mechanism 557 to assist with alignment of the receiver 563 positioned on the moveable surface 551 such as a seat assembly and a transmitter positioned on a stationary surface such as a desk, wall, floor mat, etc. The alignment mechanism 557 can comprise a moveable arm containing the transmitter, an extendable flap or hinged surface, or a manually or automatically-powered mechanism to adjust vertical, horizontal, or longitudinal position of the receiver and/or the transmitter as the receiver and transmitter approach each other. Additionally, the support surface 551 can comprise a visual indicator 565, such as one or more lights that can illuminate when the receiver and transmitter are aligned and charging a battery. Additional details regarding the alignment mechanism and the visual indicator are discussed below.

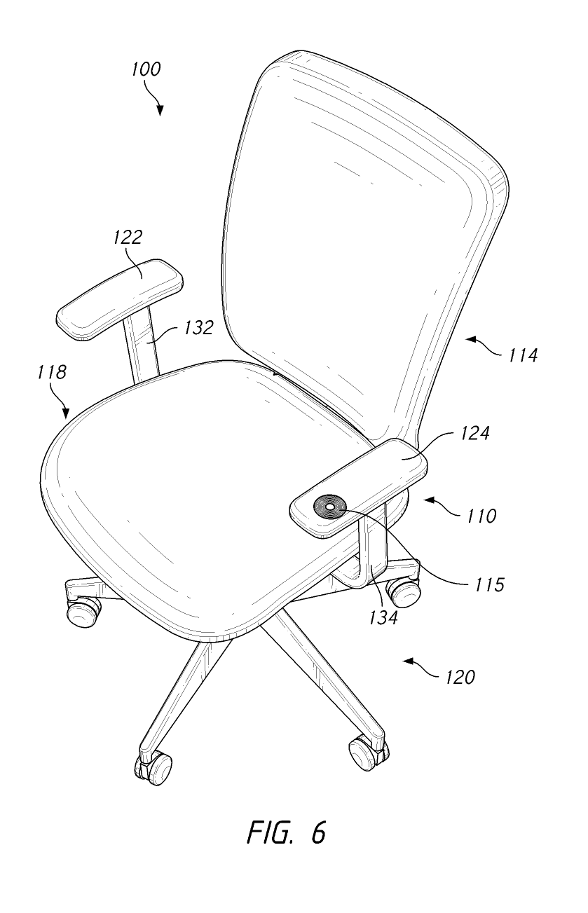

FIG. 6 is a perspective view illustrating an exemplary personal thermal amenity device such as a seating assembly 100 that can include a climate control system as described above and can include an inductive charging system 110. As illustrated, the seating assembly 100 may be a moveable chair, such as an office chair. As noted above, in other embodiments, the personal thermal amenity device may be any other moveable surface, such as a bed or wheelchair. The seating assembly 100 may be configured to condition predetermined areas of the body of a user in contact with the assembly 100, such as the legs, trunk, or back, using a fluid module as discussed above with respect to FIGS. 1-4.

The seating assembly 100 can comprise a backrest portion 114 and a bottom seat portion 118. The seating assembly 100 can also include a bottom base 120, which in the depicted embodiment, enables an occupant to easily move the seating assembly 100 relative to a floor or another bottom surface through the use of one or more bottom wheel assemblies. In addition, the seating assembly may be configured to swivel or rotate about a central axis. The seating assembly 100 can also include one or more other features, such as, for example, armrests 122, 124, to further enhance the appearance and/or functionality of the seating assembly 100. The armrests 122, 124 may be supported by support members 132, 134. In some embodiments, the seating assembly 100 includes one or more adjustment controls (e.g., knobs, levers) that permit the position, tension and other characteristics of the various seating assembly components (e.g., backrest portion, bottom seat portion, armrests, etc.) to be adjusted, as desired or required by a particular user or application. As noted above, the seating assembly of FIGS. 6-13 can include a climate control system as described above. However, for the sake of simplicity, components of the climate control system are not illustrated in these figures.

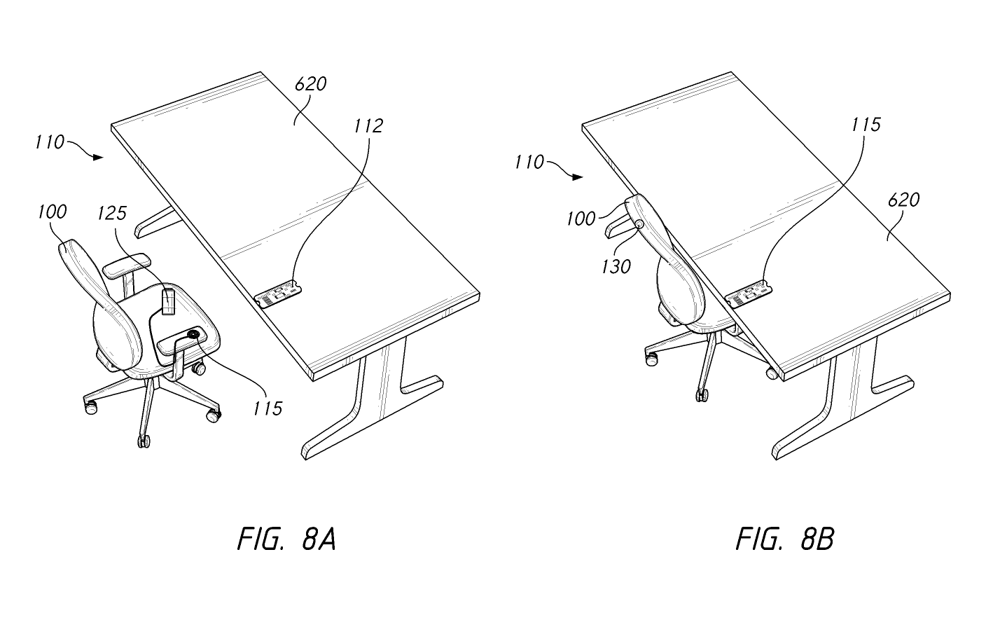

With continued reference to FIG. 6, in some embodiments, at least one of the armrests 122, 124 includes an inductive charging connection such as receiver 115 for use as part of the inductive charging system 110 and in some embodiments for charging a battery. The receiver 115 charges one or more batteries and/or supplies power to one or more components associated with personal thermal devices, such as a fluid module, installed on the seating assembly 100 using electromagnetic fields to transfer power from a transmitter to the receiver (e.g., the power source in the assembly) that is in close proximity to the transmitter. As shown in FIGS. 8A-B, in one embodiment the transmitter can be positioned under or on a desk top and the receiver 115 communicates with transmitter only or best when the armrest is at least partially located under the desk as shown in FIG. 8B, such as, for example, when the occupant is working and/or slides the chair under the desk top before leaving the office of a period. A light or other visual indicator can be positioned on the chair, receiver, transmitter and/or desk to indicate charging status.

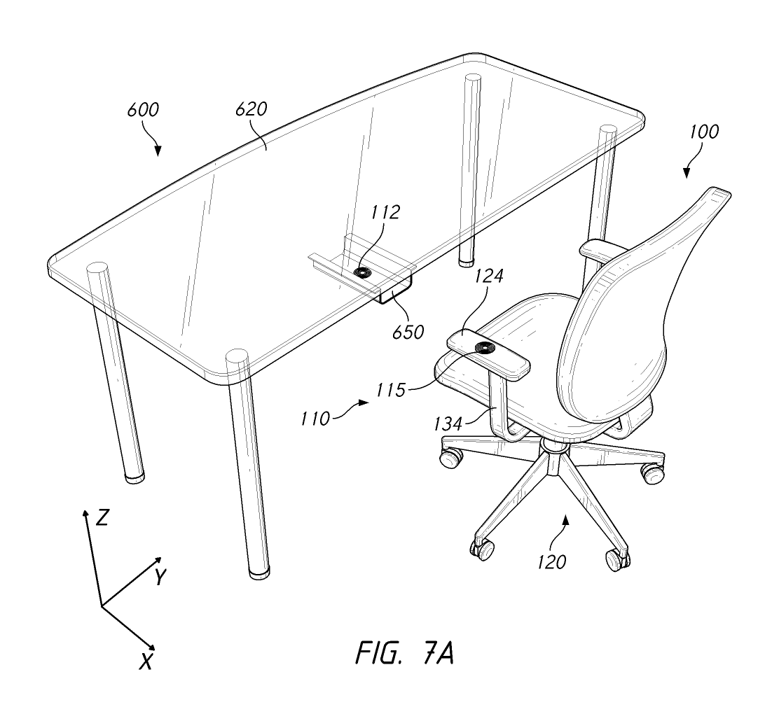

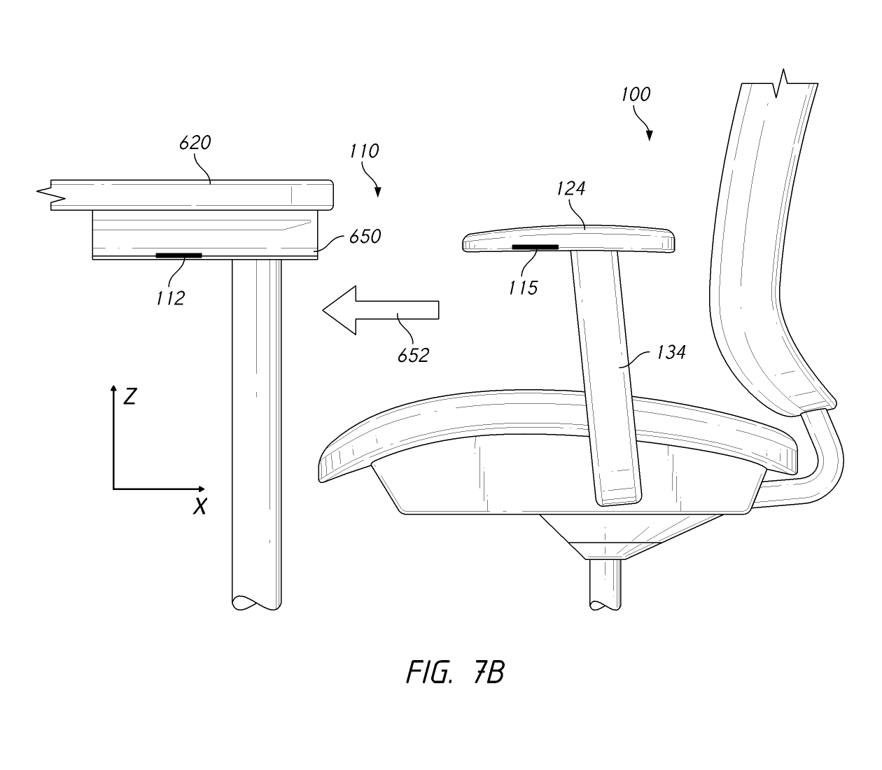

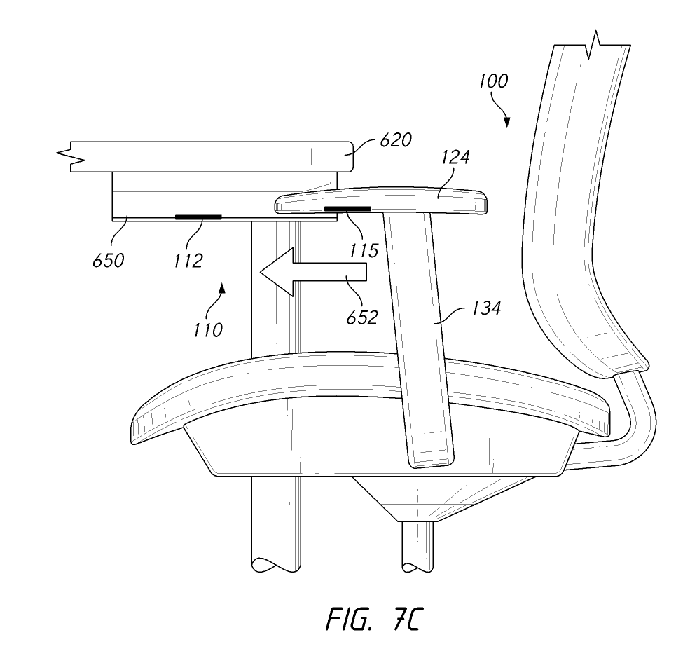

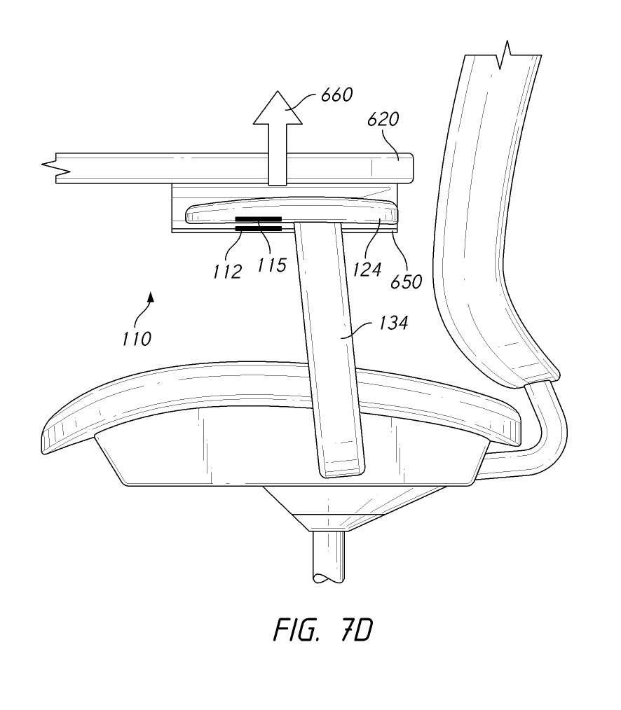

FIGS. 7A-D illustrate an embodiment of an inductive charging system 110 that can include the receiver 115 installed into the armrest 124 of the seating assembly 100 and a transmitter 112 installed on an underside of a desktop 620. In some embodiments, an alignment mechanism or cradle 650 may be attached to the underside of the desktop 620 to assist with alignment of the receiver 115 and the transmitter 112. As explained below, in one embodiment the cradle 650 can form a channel or recess configured to receive a portion of the seating assembly 100 (arm rest 124 in the illustrated embodiment) that carries the receiver 115.

In the illustrated sequence shown in FIGS. 7B-D, the seating assembly 100 is moved in the direction 652 toward the desktop surface 620. To guide alignment of the transmitter 112 and the receiver 115, the armrest 124 is directed toward the cradle 650. Alignment of the transmitter 112 and the receiver 115 in the X, Y, and Z directions (that is, horizontally, vertically, and longitudinally) is important for proper inductive charging. The cradle 650 provides a physical alignment target for the armrest 124 containing the receiver 115. In some embodiments, as best illustrated in FIGS. 7C and 7D, the receiver 115 is located closer to an underside of the armrest 124 such that the distance between the receiver 115 and the transmitter 112 when the armrest 124 is docked within the cradle 650 is minimized. The X, Y, and/or Z distance between the transmitter 112 and the receiver 115 can affect the efficiency of the charging operation. In some embodiments, with respect to the Z direction the wireless inductive charging occurs when the distance between the coils of the transmitter and the coils of the receiver is 1 to 10 mm in the Z direction and in another embodiment 1 to 5 mm in the Z direction. With respect to the X and Y directions, inductive charging can occur when the centers of the coils of the receiver and coils of the transmitter are 0 to 10 mm of each other in an X-Y plane and in another embodiment 5 and 25 mm of each other in the X-Y plane. In another embodiment with respect to the X and Y directions, inductive charging can occur when in X-Y plane there is 30% or less area offset between the coils of the receiver and coils of the transmitter (with area offset being defined as the percentage area of within the coils not overlapped in the X-Y plane by the other coil). In certain embodiments, the alignment mechanism arrangements disclosed herein can be configured to bring the coils of the transmitter and receiver within the ranges disclosed above for the X, Y, and/or Z directions to facilitate more efficient wireless inductive charging. In certain embodiments, the visual indicators described herein can also be configured to activate when the coils of the transmitter and receiver are within the ranges disclosed above for the X, Y, and/or Z directions to facilitate more efficient wireless inductive charging. In some embodiments, as shown in FIG. 7D, the support 134 of the armrest 124 may be raised in the direction 660, manually or automatically, to facilitate insertion of the armrest 124 into the cradle 650.

FIGS. 8A and B are perspective views illustrating another embodiment of the inductive charging system 110 in further detail. As discussed above with respect to FIGS. 7A-D, the inductive charging system 110 of the illustrated embodiment can include a transmitter 112 and the receiver 115 for charging a battery 125 included with the seating assembly 100. The transmitter 112 can be located on a lower surface of the desktop 620 opposite a working surface. The receiver 115 can be located on or near an upper surface of an armrest of the seating assembly 100. The receiver 115 communicates with the transmitter 112 only or best when the armrest is at least partially located under the desktop 620 as shown in FIG. 8B, for example when the occupant is working or slides the chair under the desktop 620 before leaving the office for a period. In some embodiments, a light 130 can indicate charging status by illuminating when the receiver 115 and the transmitter 112 are at least partially aligned in the X, Y, and Z directions and/or within one or more of the X, Y, and Z ranges described above. In other embodiments, the illumination of the light 130 may increase with increased alignment of the receiver 115 and the transmitter 112. The light 130 may remain illuminated for the entirety of the time the receiver and the transmitter are aligned, or the light 130 may shut off when the battery is fully charged.

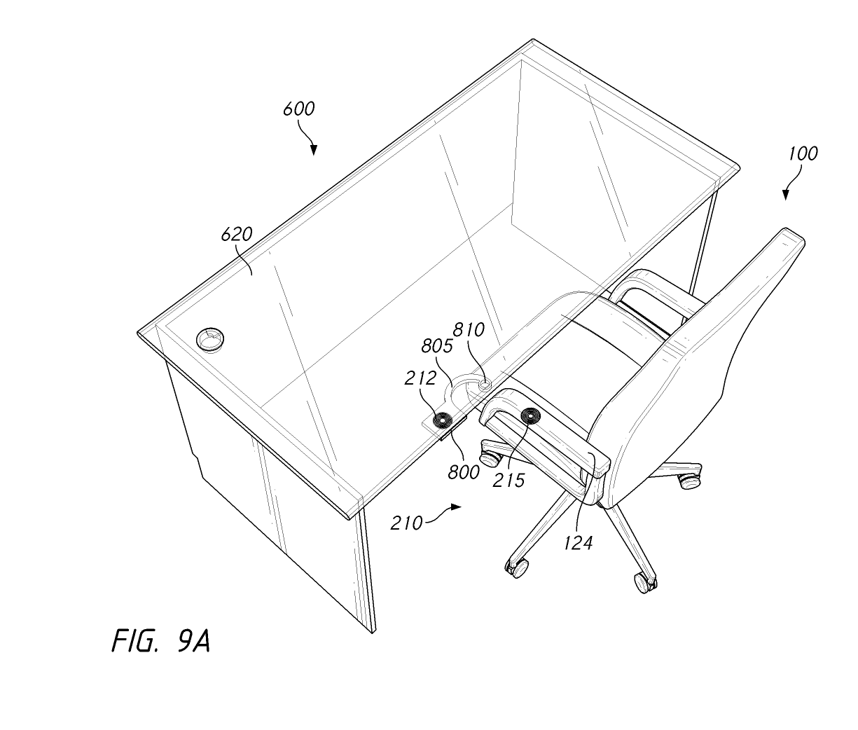

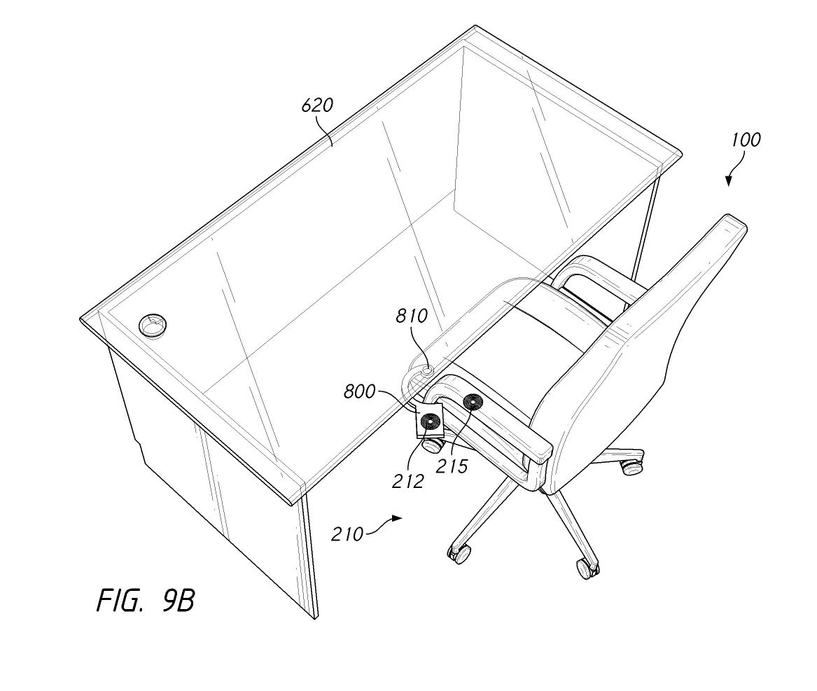

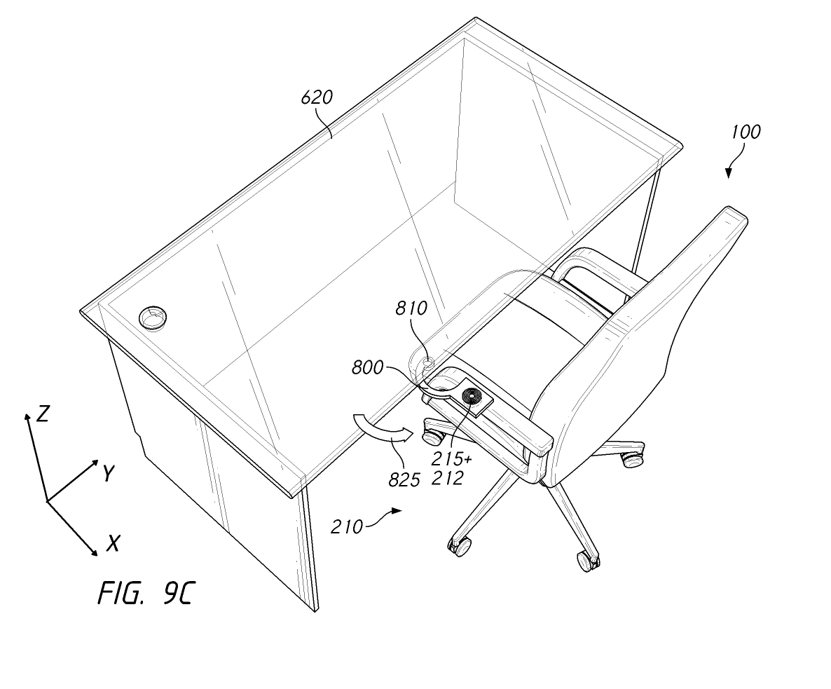

FIGS. 9A-C illustrate another embodiment of an inductive charging system 210 that may be used with seating assembly 100. The receiver 215 is located on or near the upper surface of the armrest 124 of the seating assembly 100, as described above. The transmitter 212 can be located on an alignment mechanism that comprises a rotatable member 800 connected at a pivot point 810 to the underside of the desktop work surface 620. The rotatable member 800 includes an arm 805 that forms an arc such that the transmitter 212 may be rotated out from underneath the desktop surface to align with the receiver 215 mounted in the armrest 124 of the chair 100. As the arm 805 swings out from underneath the work surface 620, as shown in FIG. 8C by arrow 825, the transmitter 212 can be aligned above the receiver 215 to inductively charge a battery (not shown) on the seating assembly 100. As the transmitter 212 is on a rotatable arm, the position of the transmitter 212 can be easily adjusted to optimize the X, Y, and Z axes alignment of the transmitter 212 and the receiver 215.

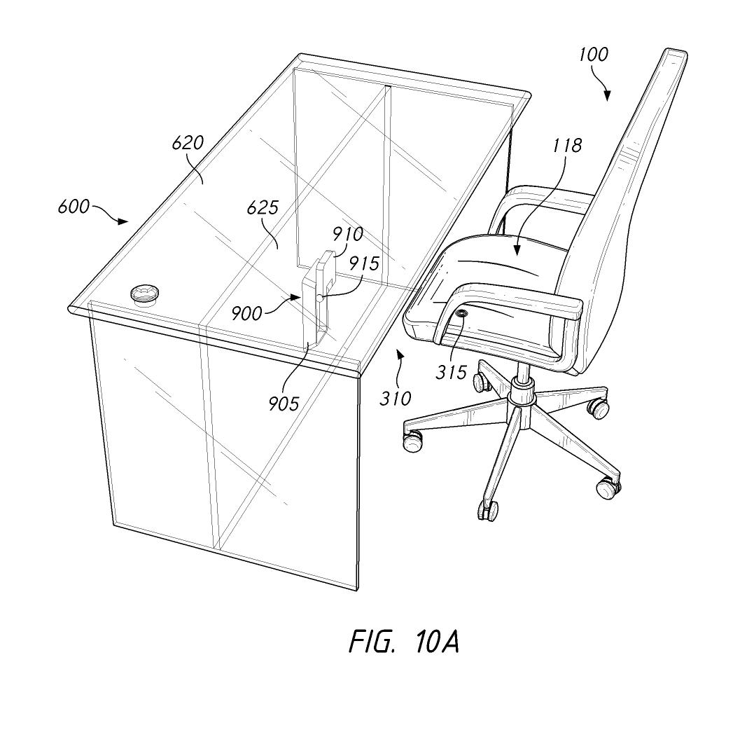

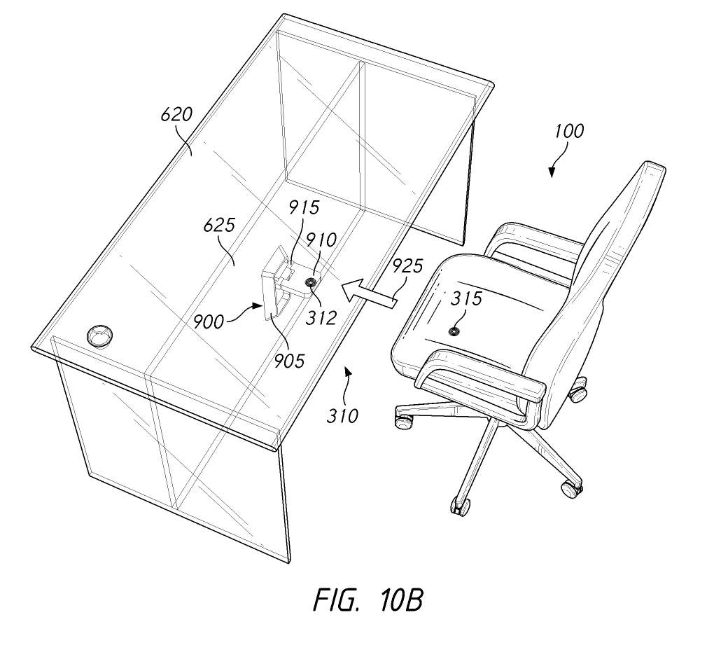

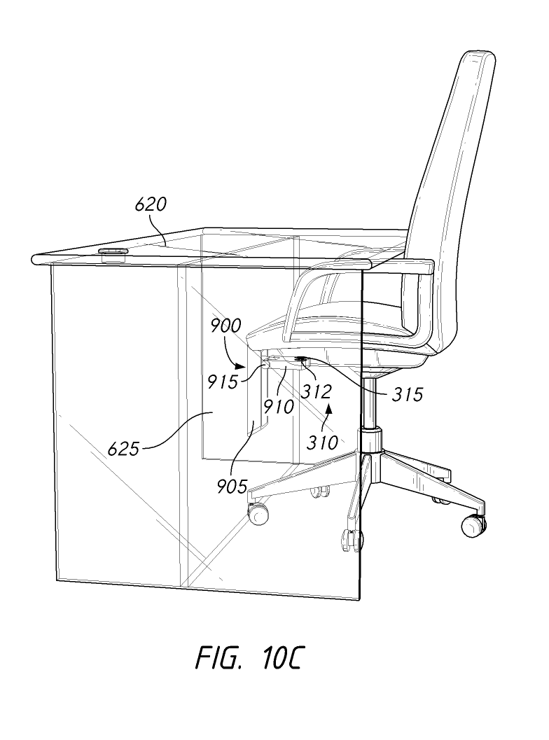

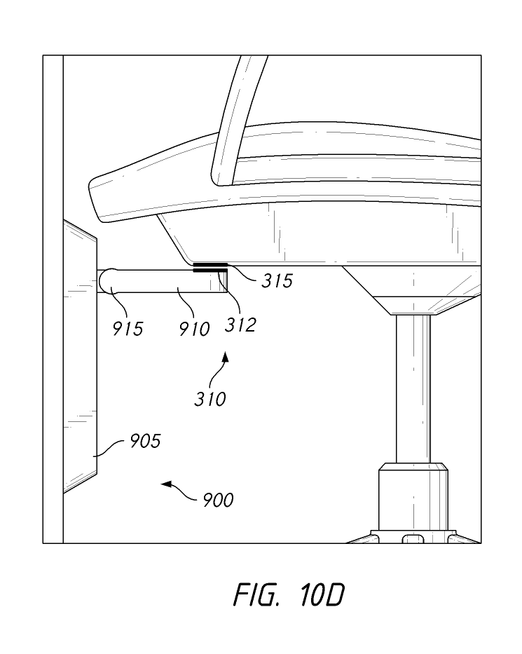

Another embodiment of an inductive charging system 310 that may be used with seating assembly 100 is shown in FIGS. 10A-D. As illustrated, the receiver 315 is located on an underside of the bottom seat portion 118 of the seating assembly 100. In this embodiment, the alignment mechanism can comprise an enclosure 900 that is attached to vertically-oriented undersurface 625 of the desk 600. The undersurface 625 may be one of the surfaces that support the work surface 620. The enclosure 900 includes a housing 905 and a transmitter support 910 attached to the housing 905 by a hinge 915. The transmitter support 910 can be extended outward from the undersurface 625 either manually or automatically, exposing the transmitter 312 as shown in FIG. 10B. As the seating assembly 100 moves so that at least part of the bottom seat portion 118 is underneath the work surface 620, as shown by the arrow 925 of FIG. 10B and in FIGS. 10C and D, the receiver 315 and the transmitter 312 can be vertically, horizontally, and longitudinally aligned (for example, within the ranges described above) to inductively charge a battery installed on the seating assembly 100.

In some embodiments, the hinge 915 may be connected to the housing 905 such that the transmitter support 910 can slide vertically within the housing 905. Once the hinge 915 has slid to the bottom of the housing 905, the transmitter support 910 may be enclosed within the housing 905 with the transmitter 312 facing an interior surface of the housing 905.

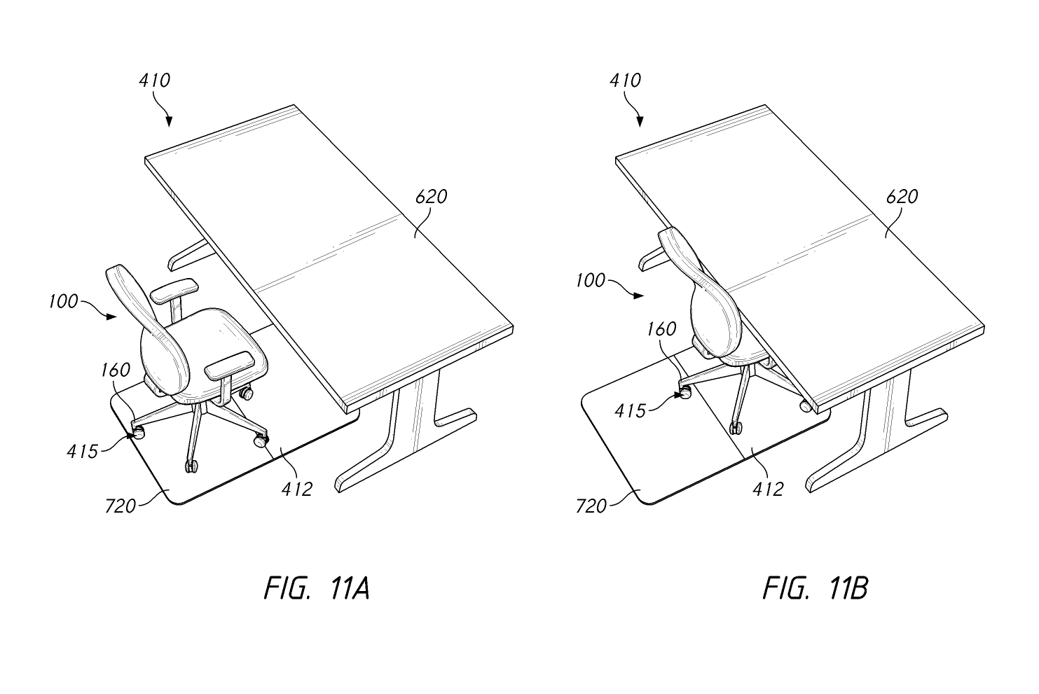

In some embodiments, the transmitter can be a pad or other surface upon which the seating assembly rests or rolls. FIGS. 11A-B are perspective views illustrating another exemplary inductive charging system 410 according to the present disclosure. The inductive charging system 410 includes a transmitter 412 and a receiver 415 for charging a battery (not shown) included with a seating assembly 100. The transmitter 412 can be located on or near an upper surface of a floor mat 720 in an area located under the desk top 620. The receiver 415 can be located in or operably coupled to one or more wheels 160 of the seating assembly 100. The receiver 415 communicates with the transmitter 412 when the wheels 160 roll over the area where the transmitter 412 is located and/or when the receiver 415 and transmitter 412 are within the X, Y and Z ranges described above.

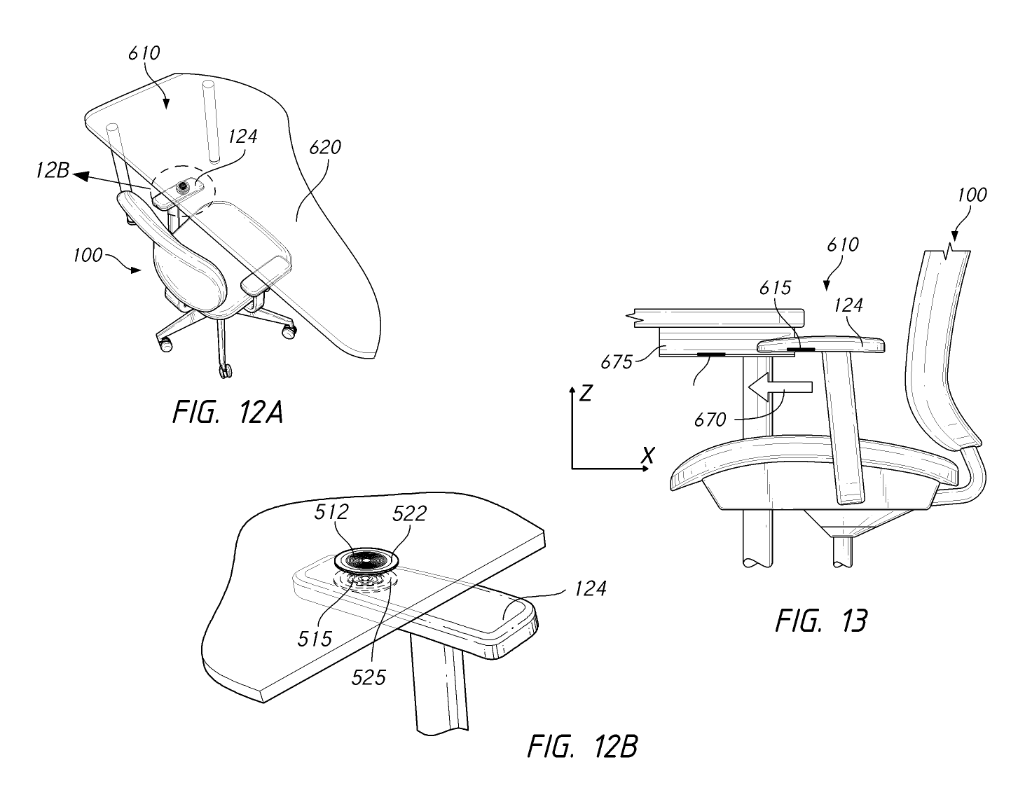

FIG. 12A illustrates a perspective view of an exemplary inductive charging system 510 according to the present disclosure. FIG. 12B illustrates a closer view of the inductive charging system 510 shown in FIG. 12A. The inductive charging system 610 includes a transmitter 512 that can be directly attached to an undersurface of the work surface 620. The transmitter 512 communicates with the receiver 515 located within the armrest 124 of the seating assembly 100. As discussed above, alignment of the transmitter and the receiver in the X, Y, and Z directions is important in inductive charging. The inductive charging system 610 can include an alignment mechanism comprising of a first magnet 522 surrounding or proximal to the transmitter 512 and a second magnet 525 surrounding or proximal to the receiver 515. As the magnet pair 522, 525 approach each other, the magnetic force will assist in correct alignment of the transmitter 512 and the receiver 515.

In other embodiments, an alignment mechanism can be part of the cradle or dock within which the transmitter is mounted. FIG. 13 illustrates a side view of another exemplary inductive charging system 610. The inductive charging system 610 includes a spring-loaded or hinged transmitter mount or dock 675 that can move, manually or automatically, to accommodate the armrest 124 as the seating assembly 100 approaches the mount 675. Sensors or other mechanisms can be used to determine the proximity of the armrest 124 and the receiver 615 and can trigger the mount 675 to raise or lower to facilitate alignment of the receiver 615 and the transmitter 612 mounted to the mount 675.

The inductive charging systems 110, 210, 310, 410, 510, and 610 can charge and/or receive power via moveable surfaces (e.g. armrest of the chairs 100) associated with one or more of the personal thermal amenity devices (e.g. the chairs 100). The battery, such as battery 125 can supply power when the moveable surfaces are away from the inductive source, which can be located in a stationary surface (e.g. desk tops 620). Charging can commence when the moveable surfaces are near the inductive source.

In the embodiments described above, the inductive charging systems 110, 210, 310, 410, 510, and 610 are described as providing power to a climate control system either directly or through a battery associated with the climate control system that is recharged. In other embodiments, the inductive charging systems 110, 210, 310, 410, 510, and 610 can be used to charge climate control systems of different arrangements and/or other devices such as PEDs that are carried and/or coupled to the chair such as music players, video devices, communications devices (phones), headphones, etc.

### Office Climate Control System

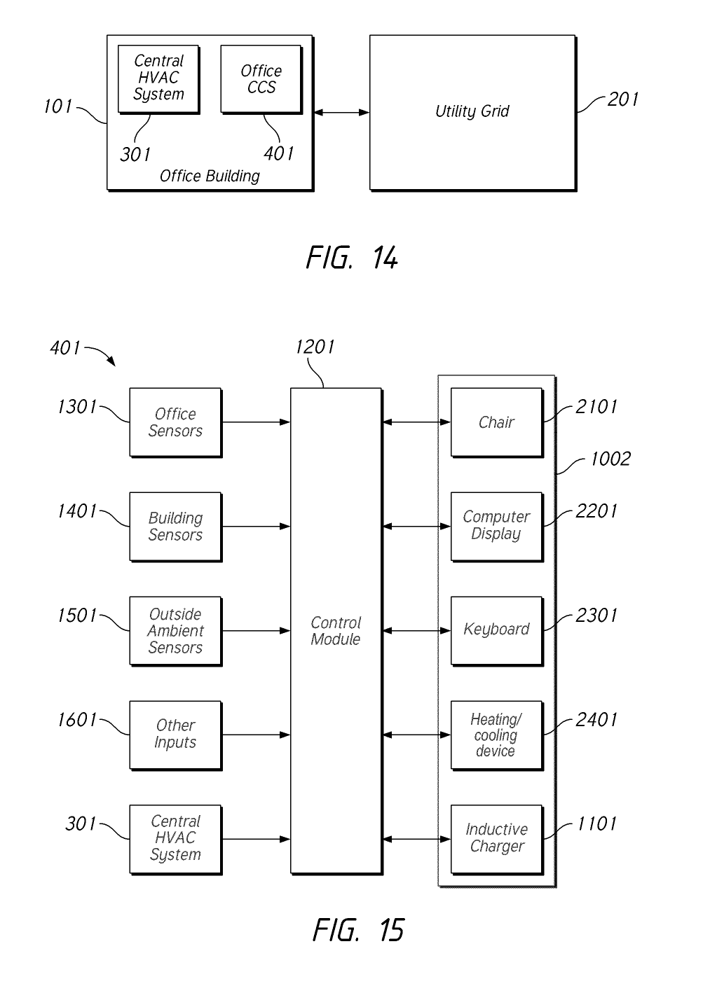

FIG. 14 is a functional block diagram illustrating an exemplary office building 101 according to the present disclosure. An electrical utility grid 201, alone or in combination with other power sources, powers the office building 101. The office building 101 includes a central HVAC system 301 and at least one office climate control system (CCS) 401. For simplicity, a single office CCS 401 is shown, however an office CCS 401 can be provided for each office of the building 101. The central HVAC system 301 can employ conventional heating and cooling.

FIG. 15 is a functional block diagram illustrating the office CCS 401. The office CCS 401 includes personal thermal amenity devices 1001, an inductive charger 1101, and a control module 1201. The personal thermal amenity devices 1001 each independently condition respective zones within an office and predetermined areas of the body of an occupant (not shown). The inductive charger 1101 charges one or more of the personal thermal amenity devices 1001. The control module 1201 is operably coupled to and controls operation of the personal thermal amenity devices 1001 and the inductive charger 1101. In various embodiments, the control module 1201 further communicates with the central HVAC system 301 and receives inputs from office sensors 1301, building sensors 1401, outside ambient sensors 1501, and other inputs 1601. The sensors 1301, 1401, 1501 can measure various conditions, including climate conditions (e.g. temperature, humidity, sunlight or solar load), power consumption conditions (e.g. current, peak demand periods), occupant conditions (e.g. presence, movement, speech or sound, body temperature) and lighting conditions (e.g. fluorescent light).

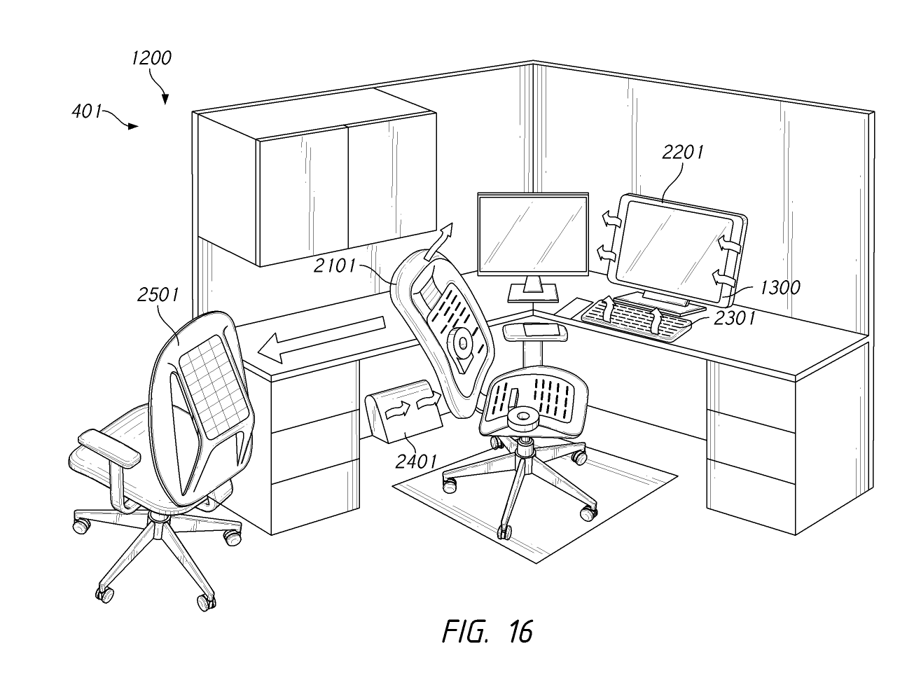

FIG. 16 is a perspective view illustrating the office CCS 401 in an office 1200 in further detail. The personal thermal amenity devices 1001 include a chair 2101, a computer display 2201, a keyboard 2301, and a heating/cooling device 2401. The chair 2101 provides convective and/or conductive heating and cooling to an occupant through occupant support surfaces (e.g. seat bottom and back, armrest) and other areas of the seat proximate specific areas of the occupant's body (e.g. neck). The chair 2101 can include a solar panel 2501 located in a seat back. The display 2201 can be located above a desk work surface and provides convective heating and cooling to an occupant by blowing unconditioned or conditioned air out of a frame 1300 towards the occupant and, more specifically the face and/or upper body. The keyboard 2301 can be located between the display 2201 and the desk work surface and provides convective heating and/or cooling to an occupant by blowing unconditioned or conditioned air out of the keyboard 2301 towards the occupant and, more specifically the palm of the hands, wrist, upper body, neck, and or face. The heating/cooling device 2401 can be located on the floor of the office beneath the desk work surface and provides convective and/or radiative heating and/or cooling to an occupant and, more specifically, the lower body and feet.

Discussion of the various embodiments herein has generally followed the embodiments schematically illustrated in the figures. However, it is contemplated that the particular features, structures, or characteristics of any embodiments discussed herein may be combined in any suitable manner in one or more separate embodiments not expressly illustrated or described. In many cases, structures that are described or illustrated as unitary or contiguous can be separated while still performing the function(s) of the unitary structure. In many instances, structures that are described or illustrated as separate can be joined or combined while still performing the function(s) of the separated structures.

Various embodiments have been described above. Although the present teachings have been described with reference to these specific embodiments, the descriptions are intended to be illustrative and are not intended to be limiting. Various modifications and applications may occur to those skilled in the art without departing from the spirit and scope of the teachings described herein.

1-10. (canceled)

11. A climate controlled seating assembly comprising:
a front side and a rear side, said front side of the seating assembly being generally adjacent to a seated occupant;
at least one covering material located along the front side of the climate controlled seating assembly, said at least one covering material being generally air-permeable and being configured to contact a seated occupant;
a fluid module connected to a distribution system configured to distribute air through the at least one covering material toward one or more targeted areas of the seated occupant;
a rechargeable battery connected to the fluid module and configured to power the fluid module;
a receiver connected to the seating assembly and to the battery; and
a transmitter connected to a power source.

12. The climate controlled seating assembly of claim 11, comprising an alignment mechanism that configured to align with the transmitter with the receiver when at least a portion of the seating assembly is in proximity to the power source such that when the transmitter and the receiver are aligned the battery is at least partially recharged.

13. The climate controlled seating assembly of claim 11, wherein the climate controlled seating assembly is one of a bed, wheelchair, or office chair.

14. The climate controlled seating assembly of claim 11, wherein the transmitter is on one of a desk, wall, or floor mat.

15. The climate controlled seating assembly of claim 11, wherein the receiver and transmitter are aligned in each of the X, Y, and Z directions.

16. The climate controlled seating assembly of claim 11, wherein the transmitter is connected to a rotatable member pivotally connected to a stationary surface.

17. The climate controlled seating assembly of claim 12, wherein the transmitter is connected to a hinged support that extends from a housing connected to a surface.

18. The climate controlled seating assembly of claim 12, wherein the transmitter is positioned within a channel or recess configured to receive a structure of a chair comprising the receiver.

19. The climate controlled seating assembly of claim 12, further comprising a visual indicator that activates when the transmitter and the receiver are aligned and the battery is at least partially being recharged.

20. (canceled)

21. A method of wireless charging a rechargeable battery or powering electrical components carried by a moveable surface, the method comprising:
moving a device comprising an electrical component and a receiver towards a transmitter, the rechargeable battery connected to the moveable surface; and
aligning the transmitter with the receiver using an alignment mechanism to wirelessly provide power to the battery or the electrical component.

22. A charging system for a moveable surface, the charging system comprising:
a receiver connected to the moveable surface and to a battery;
a transmitter connected to a power supply; and
an alignment mechanism that is configured to align the transmitter with the receiver when at least a portion of the moveable surface is in proximity to the transmitter such that when the transmitter and the receiver are aligned, power is being transmitted from the transmitter to the receiver.

23. The charging system of claim 22, wherein the moveable surface is one of a bed, wheelchair, or office chair.

24. The charging system of claim 22, wherein the transmitter is on one of a desk, wall, or floor mat.

25. The charging system of claim 22, wherein the receiver and transmitter are aligned in each of the X, Y, and Z directions.

26. The charging system of claim 22, wherein the transmitter is connected to a rotatable member pivotally connected to a surface.

27. The charging system of claim 26, wherein the receiver is connected to an armrest of a moveable chair such that at least a portion of the moveable chair approaches the transmitter, the rotatable member allows the transmitter to align with the receiver.

28. The charging system of claim 27, wherein the transmitter is positioned within a channel or recess configured to receive a structure of the moveable chair comprising the receiver.

29. The charging system of claim 22, wherein the transmitter is connected to a hinged support that extends from a housing connected to a surface.
